(19) United States
(12) Patent Application Publication
(10) Pub. No.: US 2025/0246380 A1
(43) Pub. Date: Jul. 31, 2025

(54) KEY STRUCTURE

(71) Applicant: Acer Incorporated, New Taipei City (TW)

(72) Inventor: Hung-Chi Chen, New Taipei City (TW)

(73) Assignee: Acer Incorporated, New Taipei City (TW)

(21) Appl. No.: 19/006,227

(22) Filed: Dec. 31, 2024

(30) Foreign Application Priority Data
Jan. 30, 2024 (TW) 113103589

(51) Int. Cl. H01H 13/14; H01H 13/20

(52) U.S. Cl. CPC H01H 13/14; H01H 13/20

(57) ABSTRACT

A key structure including a base plate, a membrane circuit, a keycap, a lifting assembly, a telescopic assembly and a dome switch is provided. The membrane circuit is disposed on the base plate. The lifting assembly is disposed between the base plate and the keycap. The telescopic assembly is disposed between the membrane circuit and the keycap, and includes a first sleeve, a second sleeve, a first spring and a second spring. The first sleeve is slidably connected to the keycap and is provided with a lateral protrusion at a bottom thereof. The second sleeve is rotatably and slidably connected to the keycap, and is sleeved on the first sleeve. A bottom of the second sleeve is provided with a notch corresponding to the lateral protrusion. The first spring is disposed in the first sleeve and contacts the first sleeve and the keycap. The second spring is disposed in the second sleeve and contacts the second sleeve and the keycap. The dome switch is integrated into the bottom of the first sleeve and contacts the membrane circuit.

### CROSS-REFERENCE TO RELATED APPLICATION

This application claims the priority benefit of Taiwan application serial no. 113103589, filed on Jan. 30, 2024. The entirety of each of the above-mentioned patent applications is hereby incorporated by reference herein and made a part of this specification.

### BACKGROUND

### Technical Field

The disclosure relates to a key structure, and in particular to a key structure applied to a keyboard.

### Description of Related Art

Keyboards are common physical operating interfaces and are widely used in desktop computers, notebook computers or other electronic devices. Based on differences in structural design, trigger stroke and trigger mechanism, keyboards can be broadly divided into membrane keyboards and mechanical keyboards. In general, the mechanical keyboards can be divided into non-contact triggers and contact triggers according to their trigger mechanisms. Among them, the non-contact triggers can sense the pressing stroke of the keycap based on optical ranging to generate a trigger signal, and the contact triggers can generate a trigger signal based on the separation and contact of two metal springs.

Whether it is a mechanical keyboard using non-contact triggering or a mechanical keyboard using contact triggering, most of them have problems such as being too thick or having a trigger stroke that is too long. In addition, during the pressing process, the trigger signal may be generated before the trigger sound is emitted, resulting in an early trigger situation, or the trigger signal may be generated after the trigger sound is emitted, resulting in a delayed trigger situation. If the time difference between the generation of the trigger signal and the emission of the trigger sound is too large, it will affect the user's operating experience.

### SUMMARY

The present disclosure provides a key structure, which not only meets the design requirements of thinness and lightness, but also helps optimize the user's operating experience.

The present invention provides a key structure including a base plate, a membrane circuit, a keycap, a lifting assembly, a telescopic assembly and a dome switch. The membrane circuit is disposed on the base plate. The lifting assembly is disposed between the base plate and the keycap. The telescopic assembly is disposed between the membrane circuit and the keycap, and includes a first sleeve, a second sleeve, a first spring and a second spring. The first sleeve is slidably connected to the keycap and is provided with a lateral protrusion at a bottom thereof. The second sleeve is rotatably and slidably connected to the keycap, and is sleeved on the first sleeve. A bottom of the second sleeve is provided with a notch corresponding to the lateral protrusion, and the notch faces the membrane circuit. The first spring is disposed in the first sleeve, and opposite ends of the first spring contacts the first sleeve and the keycap respectively. The second spring is disposed in the second sleeve, and opposite ends of the second spring contacts the second sleeve and the keycap respectively. The dome switch is integrated into the bottom of the first sleeve and contacts the membrane circuit.

Based on the above, the key structure of the present invention can provide users with a solid triggering feel through the telescopic assembly. In addition, the structural thickness and trigger stroke can be reduced through the cooperation of the telescopic assembly and the dome switch, and the time difference between the generation of the trigger signal and the emission of the trigger sound can be improved.

In order to make the above-mentioned features and advantages of the application more obvious and easier to understand, the following embodiments are given and described in detail with the accompanying drawings as follows.

### BRIEF DESCRIPTION OF THE DRAWINGS

FIG. 1 is a schematic diagram of a key structure according to an embodiment of the present invention.

FIG. 2A is a schematic cross-sectional view of the key structure of FIG. 1 along line segment A-A.

FIG. 2B is a partial enlarged schematic diagram of region R1 of FIG. 2A.

FIG. 3A is an exploded diagram of the key structure of FIG. 1.

FIG. 3B is an enlarged schematic diagram of the telescopic assembly of FIG. 3A.

FIG. 3C is a schematic diagram of FIG. 3A from another perspective.

FIG. 3D is an enlarged schematic diagram of the keycap of FIG. 3C.

FIG. 3E is an enlarged schematic diagram of the telescopic assembly of FIG. 3C.

FIG. 4A and FIG. 4B are the pressing diagrams of the key structure of FIG. 2A.

FIG. 4C is a partial enlarged schematic diagram of region R2 of FIG. 4B.

FIG. 5A to FIG. 5C are action diagrams of the key structure of FIG. 1 from another perspective.

FIG. 6A is a schematic cross-sectional view of the key structure of another embodiment of the present invention.

FIG. 6B is a partial enlarged schematic diagram of region R3 of FIG. 6A.

### DESCRIPTION OF THE EMBODIMENTS

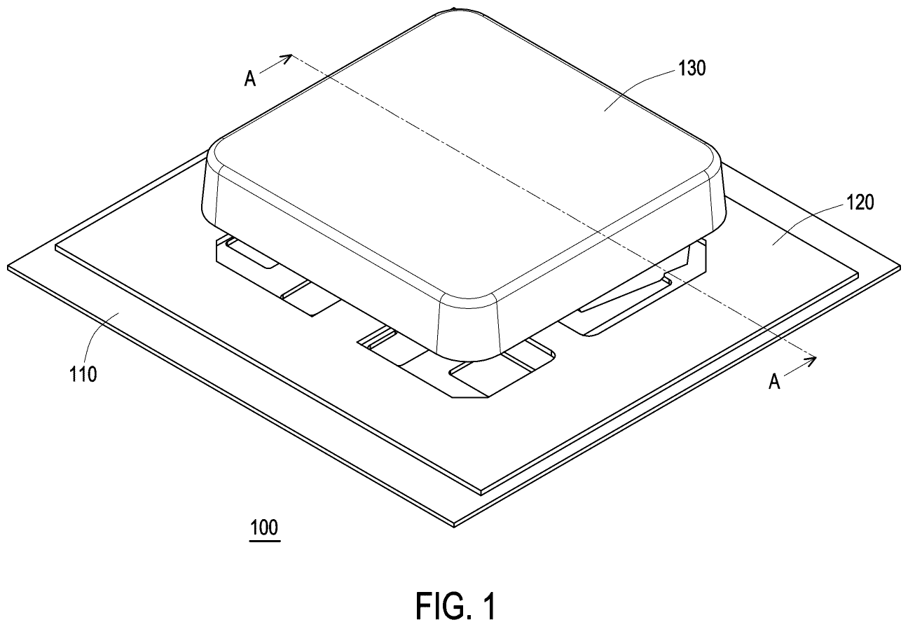

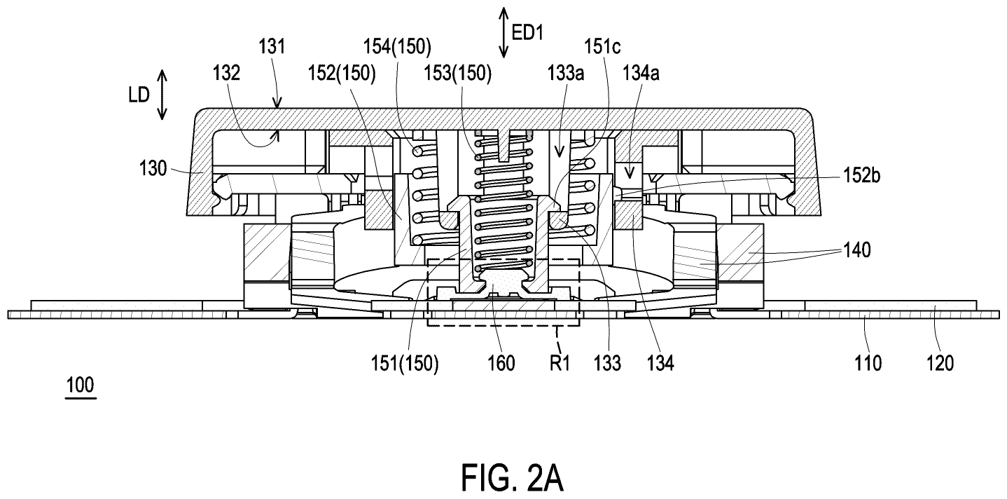

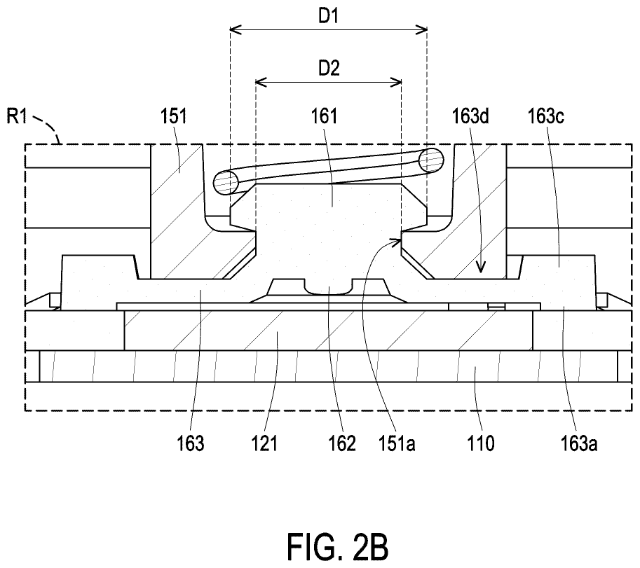

FIG. 1 is a schematic diagram of a key structure according to an embodiment of the present invention. FIG. 2A is a schematic cross-sectional view of the key structure of FIG. 1 along line segment A-A. FIG. 2B is a partial enlarged schematic diagram of region R1 of FIG. 2A. Referring to FIG. 1 and FIG. 2A, in the embodiment, the key structure 100 can be applied to a keyboard and includes a base plate 110, a membrane circuit 120, a keycap 130, a lifting assembly 140, a telescopic assembly 150 and a dome switch 160.

As shown in FIG. 2A, the membrane circuit 120 is disposed on the base plate 110, wherein the keycap 130 is disposed above the base plate 110. And the lifting assembly 140 is disposed between the base plate 110 and the keycap 130. For example, the lifting assembly 140 may adopt a scissor-foot design or a butterfly-type design to support the keycap 130 and improve the stability of the keycap 130 during the pressing and rising processes.

As shown in FIG. 2A and FIG. 2B, the telescopic assembly 150 is disposed between the membrane circuit 120 and the keycap 130 to support the keycap 130 and provide the force required for the keycap 130 to rise after being pressed down. In details, the top of the telescopic assembly 150 is connected to the keycap 130, and the dome switch 160 is connected to the bottom of the telescopic assembly 150. That is to say, the dome switch 160 is disposed between the telescopic assembly 150 and the membrane circuit 120 and contacts the membrane circuit 120. For example, the material of the dome switch 160 can be silicone or rubber to produce elastic deformation when the keycap 130 is pressed down. And during the process of the keycap 130 rising, the dome switch 160 generates elastic recovery to exert the force required when the keycap 130 rises.

As shown in FIG. 2B, the dome switch 160 is set corresponding to a contact point 121 of the membrane circuit 120, and the contact point 121 falls within an orthographic projection range of the dome switch 160 on the membrane circuit 120. When the keycap 130 is pressed down, elastic deformation occurs and the dome switch 160 contacts the contact point 121 to generate a trigger signal.

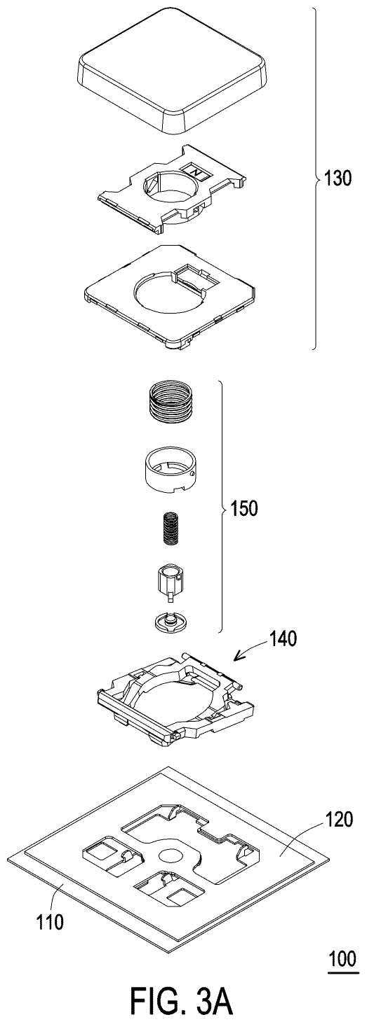

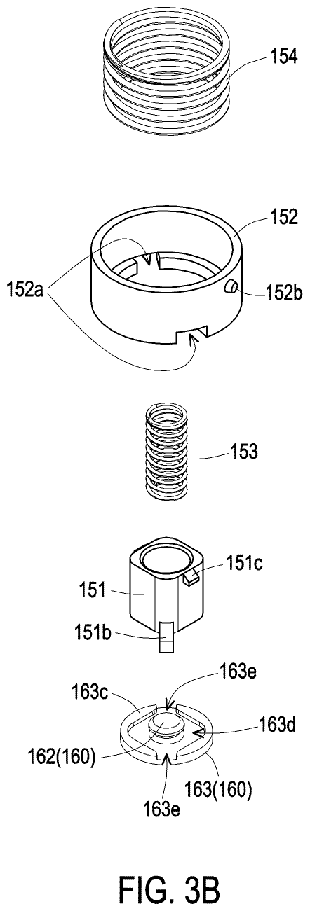

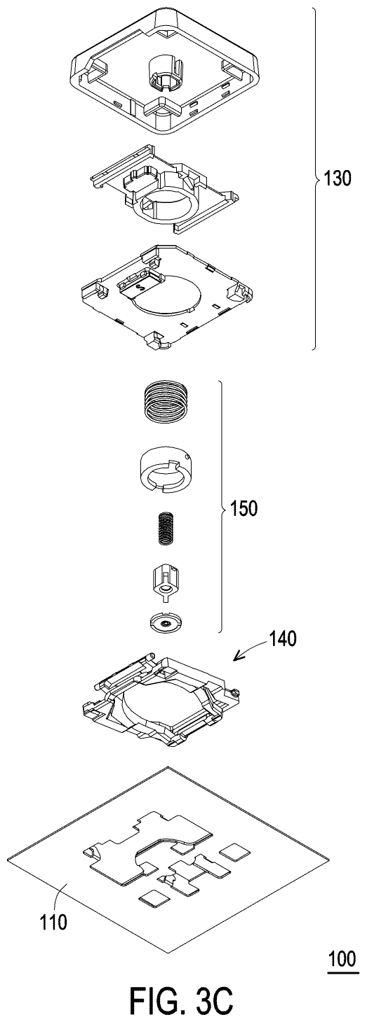

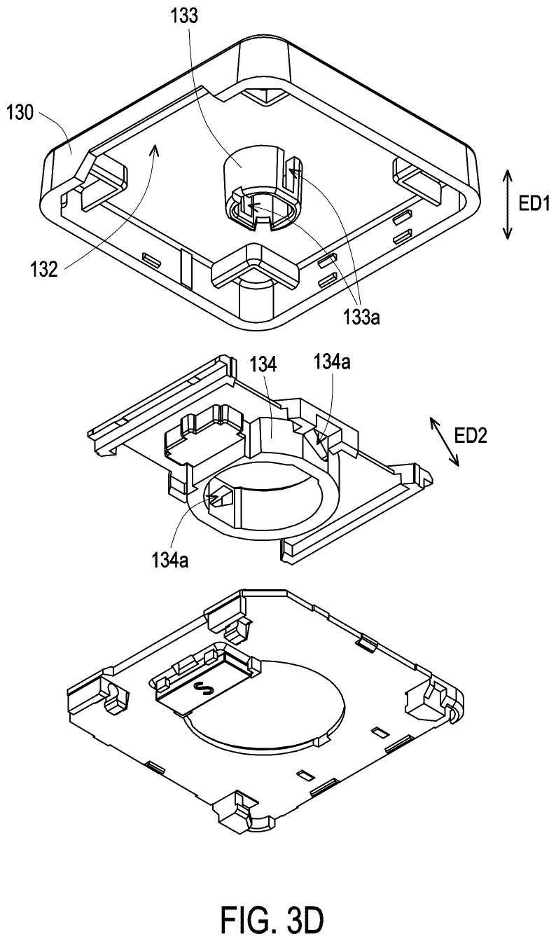

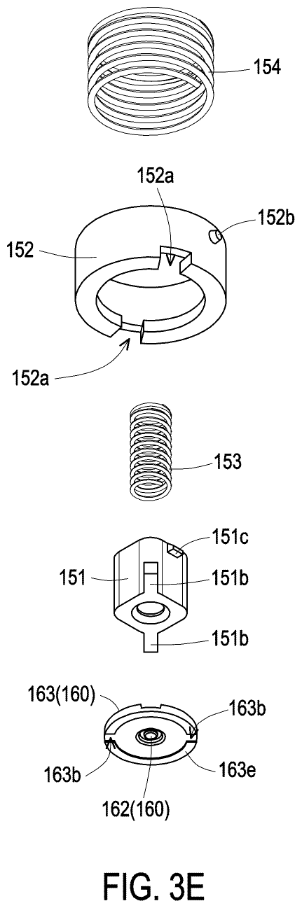

FIG. 3A is an exploded diagram of the key structure of FIG. 1. FIG. 3B is an enlarged schematic diagram of the telescopic assembly of FIG. 3A. FIG. 3C is a schematic diagram of FIG. 3A from another perspective. FIG. 3D is an enlarged schematic diagram of the keycap of FIG. 3C. FIG. 3E is an enlarged schematic diagram of the telescopic assembly of FIG. 3C. Referring to FIG. 2A, FIG. 2B, FIG. 3A and FIG. 3B or referring to FIG. 2A, FIG. 3C, FIG. 3D and FIG. 3E, in the embodiment, the telescopic assembly 150 includes a first sleeve 151, a second sleeve 152, a first spring 153 and a second spring 154, wherein the first sleeve 151 is slidably connected to the keycap 130 and the dome switch 160 is integrated into the bottom of the first sleeve 151. In addition, the second sleeve 152 is rotatably and slidably connected to the keycap 130, and is sleeved on the first sleeve 151. For example, the material of the first sleeve 151 and the second sleeve 152 can be plastic. And the dome switch 160 can be fixed to the bottom of the first sleeve 151 by snapping or gluing, or can be formed on the bottom of the first sleeve 151 by double-material injection.

As shown in FIG. 2A, the first spring 153 is disposed in the first sleeve 151, and opposite ends of the first spring 153 contacts the first sleeve 151 and the keycap 130 respectively. In addition, the second spring 154 is disposed in the second sleeve 152, and opposite ends of the second spring 154 contacts the second sleeve 152 and the keycap 130 respectively. For example, the first spring 153 and the second spring 154 can be compression springs, and an outer diameter of the second spring 154 is larger than an inner diameter of the first spring 153.

As shown in FIG. 2A, FIG. 3B and FIG. 3E, the second spring 154 surrounds the first sleeve 151 and the first spring 153 disposed in the first sleeve 151. In details, the first spring 153 and the second spring 154 can produce elastic deformation when the keycap 130 is pressed down. In the process of the keycap 130 rising, the first spring 153 and the second spring 154 produce elastic recovery to exert the force required when the keycap 130 rises.

As shown in FIG. 2B, FIG. 3B and FIG. 3E, the dome switch 160 is integrated into the bottom of the first sleeve 151, such as being engaged with the bottom of the first sleeve 151. In details, the dome switch 160 includes a head 161, a trigger portion 162 relative to the head 161 and a dome portion 163 surrounding the head 161, wherein the head 161 is engaged with the bottom of the first sleeve 151 and the dome portion 163 contacts the membrane circuit 120. In addition, the trigger portion 162 faces the contact point 121 of the membrane circuit 120.

Furthermore, the bottom of the first sleeve 151 has a positioning hole 151a, and the head 161 passes through the positioning hole 151a to engage with the bottom of the first sleeve 151. For example, an outer diameter D1 of the head 161 is larger than an inner diameter D2 of the positioning hole 151a. During the process of the head 161 penetrating into the positioning hole 151a, the head 161 undergoes elastic deformation. After the head 161 passes through the positioning hole 151a, the head 161 elastically recovers and causes structural interference with the bottom of the first sleeve 151.

As shown in FIG. 2B and FIG. 3E, the dome portion 163 has a bottom flange 163a and a vent 163b located at the bottom flange 163a, wherein the bottom flange 163a contacts the membrane circuit 120 and surrounds the contact point 121. In addition, the number of the vent 163b may be one or more than two. When the dome portion 163 undergoes collapse deformation, the gas between the dome portion 163 and the membrane circuit 120 can be discharged outward through the vent 163b.

As shown with reference to FIG. 2A, FIG. 3B, FIG. 3D and FIG. 3E, in the embodiment, the bottom of the first sleeve 151 is provided with a lateral protrusion 151b, and the lateral protrusion 151b protrudes from an outer wall surface of the bottom of the first sleeve 151. In addition, the bottom of the second sleeve 152 is provided with a notch 152a corresponding to the lateral protrusion 151b, and the notch 152a faces the membrane circuit 120. For example, the number of the notches 152a may be two, and they may be arranged symmetrically, for example, at an interval of 180 degrees.

As shown in FIG. 2B, FIG. 3B and FIG. 3E, the dome portion 163 also has a top flange 163c surrounding the head 161, a positioning groove 163d formed between the top flange 163c and the head 161, and a lateral opening 163e located at the top flange 163c. Among them, the positioning groove 163d surrounds the head 161, and the lateral opening 163e is connected to the positioning groove 163d. In details, the bottom of the first sleeve 151 is engaged with the positioning groove 163d, and the lateral protrusion 151b is engaged with the lateral opening 163e. In this way, the bonding strength between the dome switch 160 and the first sleeve 151 can not only be strengthened, but also the dome switch 160 can be prevented from rotating relative to the bottom of the first sleeve 151. For example, the number of the lateral opening 163e may be two, and they may be arranged symmetrically, for example, at an interval of 180 degrees.

As shown in FIG. 2A, FIG. 3D and FIG. 3E, the keycap 130 has a pressing surface 131 and a bottom surface 132 relative to the pressing surface 131, and the bottom surface 132 faces the membrane circuit 120. Specifically, the bottom surface 132 of the keycap 130 is provided with a first guide portion 133 and a second guide portion 134 surrounding the first guide portion 133, and the first guide part 133 and the second guide part 134 may be two hollow structures protruding from the bottom surface 132. The second guide portion 134 is sleeved on the second sleeve 152, or in other words, the top of the second sleeve 152 is inserted into the second guide portion 134. In addition, the second sleeve 152 is sleeved on the first guide portion 133, and the top of the first sleeve 151 is inserted into the first guide portion 133.

As shown in FIG. 2A, a portion of the first spring 153 is inserted into the first guide portion 133, and another portion of the first spring 153 is inserted into the first sleeve 151. On the other hand, a portion of the second spring 154 is inserted into the second guide portion 134, and another portion of the first spring 153 is inserted into the second sleeve 152. Besides, the second spring 154 surrounds the first guide portion 133.

As shown in FIG. 2A, FIG. 3D and FIG. 3E, in the embodiment, the top of the first sleeve 151 is provided with a first guide protrusion 151c. Correspondingly, the first guide portion 133 has a first guide groove 133a, and the first guide protrusion 151c is slidably disposed in the first guide groove 133a. For example, the first guide protrusion 151c protrudes from the outer wall surface of the top of the first sleeve 151, and the first guide groove 133a penetrates the inside and outside of the first guide portion 133.

In details, an extending direction ED1 of the first guide groove 133a is substantially perpendicular to the bottom surface 132 of the keycap 130, the membrane circuit 120 or the base plate 110 to determine a lifting direction LD of the keycap 130 through the cooperation of the first guide protrusion 151c and the first guide groove 133a. For example, the keycap 130 is restricted from sliding relative to the first sleeve 151 in a direction perpendicular to the bottom surface 132 of the keycap 130, the membrane circuit 120, or the base plate 110. That is, the extending direction ED1 of the first guide groove 133a is parallel to the lifting direction LD of the keycap 130.

For example, the number of the first guide protrusion 151c may be two, and they may be arranged symmetrically, for example, at an interval of 180 degrees. Correspondingly, the number of the first guide groove 133a may be two, and they may be arranged symmetrically, for example, at an interval of 180 degrees.

As shown in FIG. 2A, FIG. 3D and FIG. 3E, the second sleeve 152 is provided with a second guide protrusion 152b. Correspondingly, the second guide portion 134 has a second guide groove 134a, and the second guide protrusion 152b is slidably disposed on the second guide groove 134a. For example, the second guide protrusion 152b protrudes from the outer wall surface of the top of the second sleeve 152, and the second guide groove 134a penetrates the inside and outside of the second guide portion 134.

As shown in FIG. 3D, the first guide groove 133a can be a sliding groove in which the extending direction ED1 is perpendicular to the bottom surface 132 of the keycap 130. Correspondingly, the second guide groove 134a may be a sliding groove with an extending direction ED2 inclined to the bottom surface 132 of the keycap 130. That is to say, the extending direction ED2 of the second guide groove 134a is not parallel to the extending direction ED1 of the first guide groove 133a. As shown in FIG. 2A and FIG. 3D, through the cooperation of the second guide protrusion 152b and the second guide groove 134a, the second sleeve 152 can rotate within a limited stroke relative to the keycap 130 during the pressing or rising process of the keycap 130.

For example, the number of the second guide protrusion 152b may be two, and they may be arranged symmetrically, for example, at an interval of 180 degrees. Correspondingly, the number of the second guide groove 134a may be two, and they may be arranged symmetrically, for example, at an interval of 180 degrees.

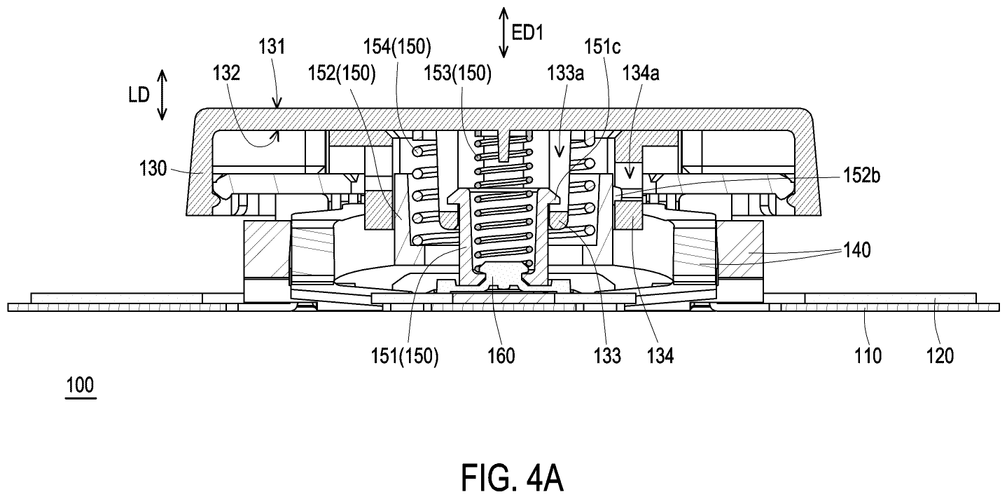

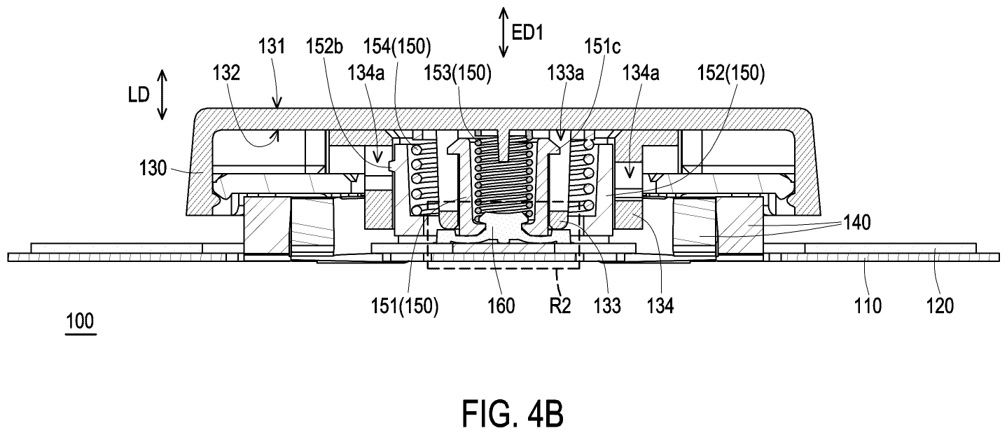

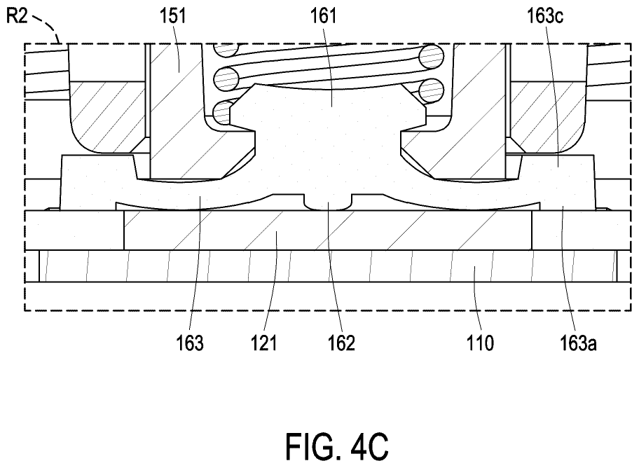

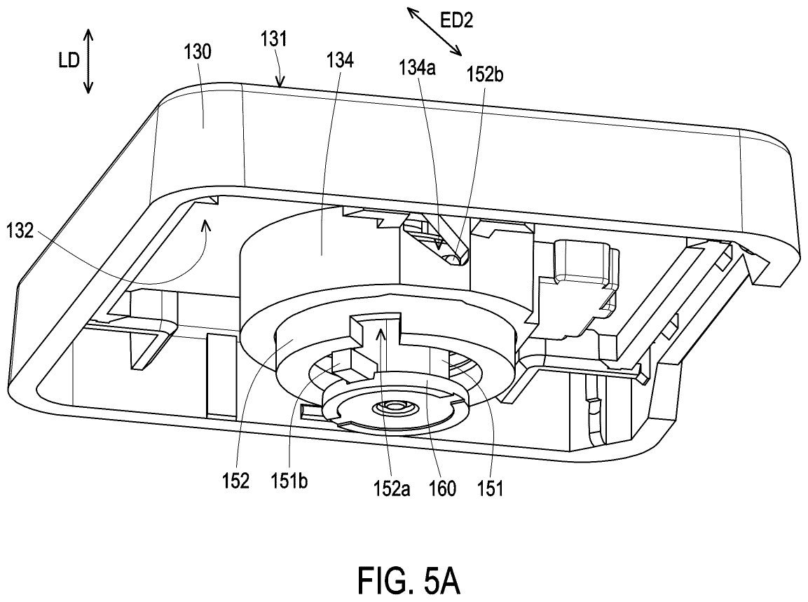

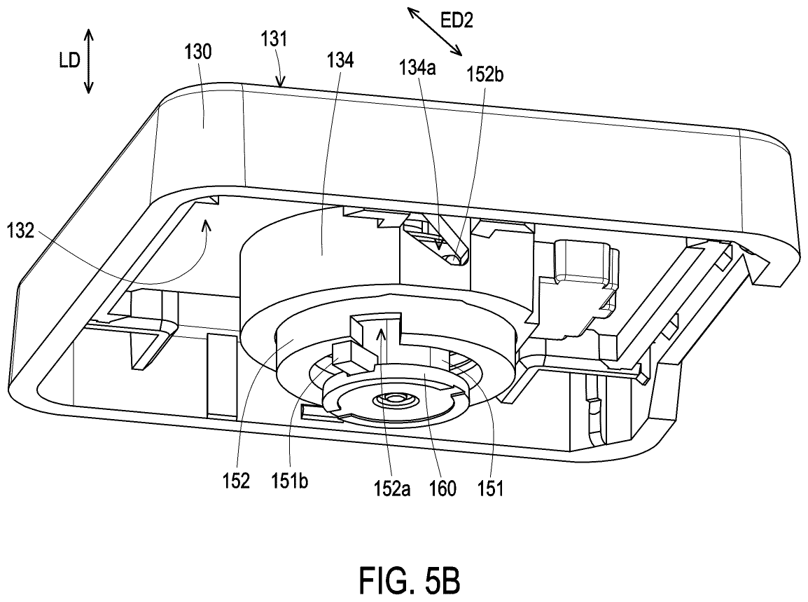

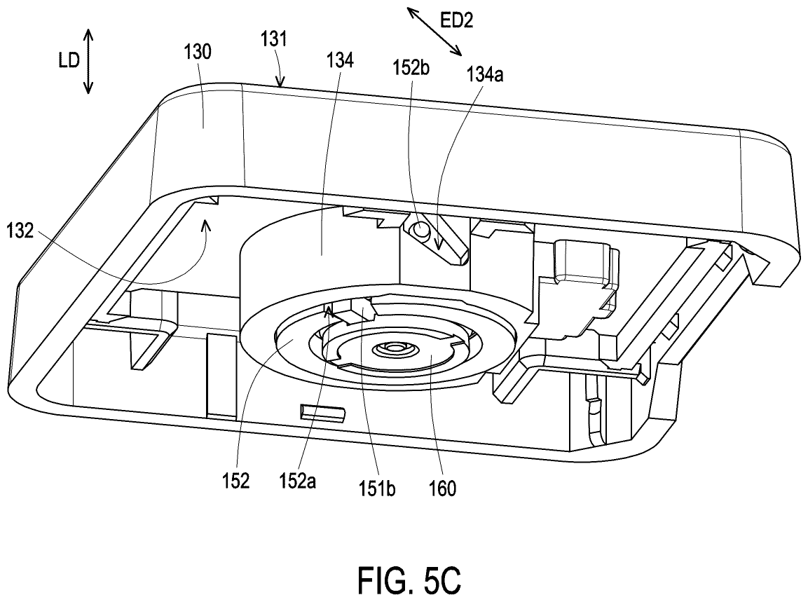

FIG. 4A and FIG. 4B are the pressing diagrams of the key structure of FIG. 2A. FIG. 4C is a partial enlarged schematic diagram of region R2 of FIG. 4B. FIG. 5A to FIG. 5C are action diagrams of the key structure of FIG. 1 from another perspective. As shown in FIG. 2A and FIG. 5A, in an initial state, the keycap 130 is not pressed down, and the bottom of the first sleeve 151 protrudes from the bottom of the second sleeve 152. In addition, the lateral protrusion 151b is misaligned with the notch 152a and is separated from the bottom of the second sleeve 152. That is to say, before the keycap 130 is pressed down, the lateral protrusion 151b does not contact the bottom of the second sleeve 152.

As shown in FIG. 4A and FIG. 5B, as the keycap 130 is pressed down toward the base plate 110, the first spring 153 is squeezed by the keycap 130. The second sleeve 152 and the keycap 130 move toward the base plate 110 simultaneously, so that the lateral protrusion 151b contacts the bottom of the second sleeve 152. After the lateral protrusion 151b contacts the bottom of the second sleeve 152, the keycap 130 is pressed down toward the base plate 110 continuously. Through the cooperation of the second guide protrusion 152b and the second guide groove 134a, the second sleeve 152 rotates relative to the keycap 130, causing the notch 152a to move toward the lateral protrusion 151b, as shown in FIG. 4B and FIG. 5C. At the same time, the first spring 153 and the second spring 154 are squeezed by the keycap 130.

As shown in FIG. 4B, FIG. 4C and FIG. 5C, when the lateral protrusion 151b is aligned with the notch 152a, the lateral protrusion 151b moves into the notch 152a, so that the lateral protrusion 151b collides with the second sleeve 152 to produce a triggering sound. On the other hand, the dome switch 160 undergoes collapse deformation and contacts the contact point 121 of the membrane circuit 120 to generate a trigger signal.

Further, during the pressing process of the keycap 130, the first spring 153 and the second spring 154 in the telescopic assembly 150 can produce elastic deformation to give the user a solid triggering feel. In addition, the cooperation of the telescopic assembly 150 and the dome switch 160 can reduce the structural thickness and trigger stroke, and improve the situation where the time difference between the trigger signal generation and the trigger sound is too large to optimize the operating experience.

For example, the elastic coefficient of the first spring 153 is 31 g/mm, and the Shore hardness of the dome switch 160 is 60 A. Through this design, the trigger stroke of the key structure 100 can be controlled between 0.2 mm and 0.5 mm to reduce the trigger stroke.

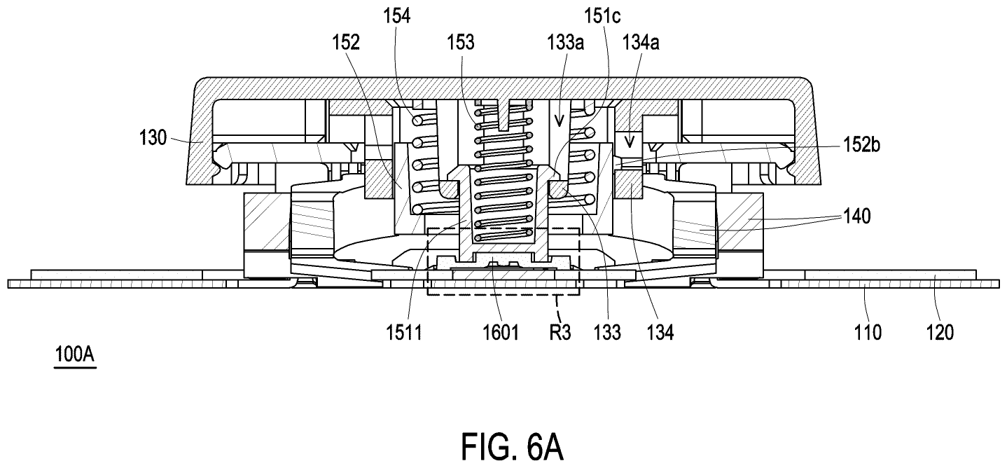

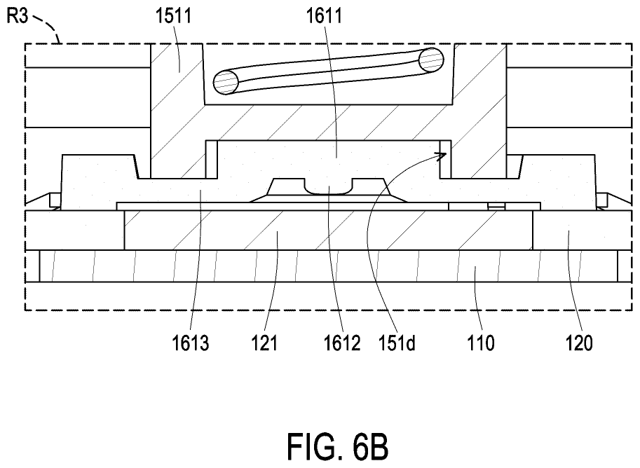

FIG. 6A is a schematic cross-sectional view of the key structure of another embodiment of the present invention. FIG. 6B is a partial enlarged schematic diagram of region R3 of FIG. 6A. Referring to FIG. 6A and FIG. 6B, the key structure 100A of the embodiment has substantially the same design principle as the key structure 100 of the previous embodiment, and the main difference is: the dome switch 1601 of the embodiment can be fixed to the bottom of the first sleeve 1511 through colloid bonding.

In details, the dome switch 1601 includes a head 1611, a trigger portion 1612 relative to the head 1611 and a dome portion 1613 surrounding the head 1611. And the bottom of the first sleeve 1511 has a positioning groove 151d. The head 1611 is inserted into the positioning groove 151d and can be fixed to the positioning groove 151d through colloid joint. In addition, the trigger portion 1612 faces a contact point 121 of the membrane circuit 120, and the dome portion 1613 contacts the membrane circuit 120.

In summary, the key structure of the present invention can provide users with a solid triggering feel through the first spring and the second spring in the telescopic assembly. In addition, the structural thickness and trigger stroke can be reduced through the cooperation of the telescopic assembly and the dome switch, and the time difference between the generation of the trigger signal and the emission of the trigger sound can be improved to optimize the operating experience.

Although the present invention has been disclosed above by the embodiments, it is not intended to limit the present invention, and any person with ordinary knowledge in the technical field is not intended to limit the present invention. Slight changes and modifications may be made without departing from the spirit and scope of the present invention, so the protection scope of the present invention should be determined by the following claims.

What is claimed is:

1. A key structure, comprising:
a base plate;
a membrane circuit, disposed on the base plate;
a keycap, disposed above the base plate
a lifting assembly, disposed between the base plate and the keycap;
a telescopic assembly, disposed between the membrane circuit and the keycap, and comprises:
a first sleeve, slidably connected to the keycap, and the first sleeve is provided with a lateral protrusion at a bottom thereof;
a second sleeve, rotatably and slidably connected to the keycap and sleeved on the first sleeve, wherein the second sleeve is provided with a notch corresponding to the lateral protrusion at a bottom thereof, and the notch faces the membrane circuit;
a first spring, disposed in the first sleeve, wherein opposite ends of the first spring contacts the first sleeve and the keycap respectively; and
a second spring, disposed in the second sleeve, wherein opposite ends of the second spring contacts the second sleeve and the keycap respectively; and
a dome switch, integrated into the bottom of the first sleeve and contacts the membrane circuit.

2. The key structure according to claim 1, wherein the dome switch snaps into the bottom of the first sleeve.

3. The key structure according to claim 1, wherein the dome switch comprises a head, and the bottom of the first sleeve is also provided with a positioning hole, the head passes through the positioning hole, and an outer diameter of the head is larger than an inner diameter of the positioning hole.

4. The key structure according to claim 1, wherein the dome switch comprises a head, a trigger portion relative to the head and a dome portion surrounding the head, and the head is engaged with the bottom of the first sleeve, the trigger portion faces a contact point of the membrane circuit, and the dome portion contacts the membrane circuit.

5. The key structure according to claim 4, wherein the dome portion has a positioning groove surrounding the head and a lateral opening connected to the positioning groove, the bottom of the first sleeve is engaged with the positioning groove, and the lateral protrusion is engaged with the lateral opening.

6. The key structure according to claim 1, wherein the dome switch comprises a head, a trigger portion relative to the head and a dome portion surrounding the head, and the bottom of the first sleeve has a positioning groove, the head is inserted and fixed in the positioning groove, the trigger portion faces a contact point of the membrane circuit, and the dome portion contacts the membrane circuit.

7. The key structure according to claim 1, wherein the keycap has a pressing surface and a bottom surface relative to the pressing surface, and the bottom surface faces the membrane circuit, the bottom surface of the keycap is provided with a first guide portion and a second guide portion surrounding the first guide portion, wherein the second guide portion is sleeved on the second sleeve, and the second sleeve is sleeved on the first guide portion.

8. The key structure according to claim 7, wherein a top of the first sleeve is inserted into the first guide portion, and the top of the first sleeve is provided with a first guide protrusion, the first guide portion has a first guide groove, and the first guide protrusion is slidably located in the first guide groove, wherein the second sleeve is provided with a second guide protrusion, and the second guide portion has a second guide groove, and the second guide protrusion is slidably located in the second guide groove.

9. The key structure according to claim 8, wherein the extension direction of the first guide groove is parallel to the lifting direction of the keycap, and the extension direction of the second guide groove is not parallel to the extension direction of the first guide groove.

10. The key structure according to claim 7, wherein a portion of the first spring is inserted into the first guide portion, and the second spring surrounds the first guide portion.

11. The key structure according to claim 1, wherein the lateral protrusion is located wrongly on the notch and is separated from the bottom of the second sleeve, when the keycap is pressed down toward the base plate, the lateral protrusion contacts the bottom of the second sleeve, and the first spring is compressed, the keycap is continuously pressed toward the base plate, causing the second sleeve to rotate relative to the keycap, and the first spring and the second spring to be compressed, when the lateral protrusion is aligned with the notch, the lateral protrusion moves into the notch, and the dome switch collapses to contact a contact point of the membrane circuit.

12. The key structure according to claim 1, wherein the elastic coefficient of the first spring is 31 g/mm, and the Shore hardness of the dome switch is 60 A.
